(19) United States
(12) Patent Application Publication
(10) Pub. No.: US 2024/0227341 A9
(43) Pub. Date: Jul. 11, 2024

(54) CONTROLLER FOR POUCH-MAKING MACHINE, POUCH-MAKING MACHINE, POUCH, CONTROL METHOD FOR POUCH-MAKING MACHINE, AND CONTROL PROGRAM FOR POUCH-MAKING MACHINE

(71) Applicant: HOSOKAWA YOKO CO., LTD., Tokyo (JP)

(72) Inventor: Shintaro Nobe, Toyko (JP)

(73) Assignee: HOSOKAWA YOKO CO., LTD., Tokyo (JP)

(21) Appl. No.: 18/547,695

(22) PCT Filed: Feb. 16, 2022
(86) PCT No.: PCT/JP2022/006124

§ 371 Date: Aug. 24, 2023

(30) Foreign Application Priority Data
Feb. 26, 2021 (JP) 2021-030539
Feb. 26, 2021 (JP) 2021030539

(51) Int. Cl. B31B 70/10

(52) U.S. Cl. CPC B31B 70/10

(57) ABSTRACT

A controller for a pouch-making machine for manufacturing a pouch while feeding a pair of film materials each provided with a reference mark that indicates a reference position for layering the film materials together, includes a driven roller shift unit for independently shifting each shaft of a pair of driven rollers that rotate being driven by the pair of film materials being fed and a control unit for controlling the driven roller shift unit based on a result of an image-shooting unit shooting images of the reference marks, so that positions of the reference marks provided on the pair of film materials coincide.

### CROSS-REFERENCE TO RELATED APPLICATION

This application claims the benefit of Japanese Patent Application No. 2021-30539 filed on Mar. 26, 2021 in Japan, the contents of which are incorporated herein by reference.

### TECHNICAL FIELD

The present disclosure relates to a controller of a pouch-making machine, a pouch-making machine, a pouch, a control method for a pouch-making machine, and a control program for a pouch-making machine.

### BACKGROUND ART

Pouch packages manufactured from film materials by pouch-making machines (hereinafter referred to as “pouches”) are conventionally and widely used for packaging various contents.

Such pouches are manufactured from two long film materials, one on top and one on bottom, printed with a print design that faces front or a print design that faces back when displayed in stores. A pouch-making machine manufactures pouches one by one by feeding two, upper and lower, film materials so that the positions of positioning print designs provided on them (hereinafter referred to as “reference marks”) coincide, sealing them, and then cutting them.

Then, the reference marks on the two film materials are sometimes misaligned on a feed line due to the machine accuracy of the pouch-making machine or to the expansion and contraction of the film materials caused by a force exerted to them in the feed process of the pouch-making machine. Consequently, the two upper and lower film materials are sealed with misalignment in longitudinal and transverse directions, which results in a pouch with front and back print designs misaligned. Such pouches have no flaw in protecting the contents, but reduce the commercial value.

For this reason, there have been developed techniques related to control for using reference marks to correct misalignment in film materials' longitudinal direction (feed direction, also called MD) and transverse direction (width direction of film materials, also called TD).

For example, Japanese Patent Application Laid-Open Publication No. 2012-224030 (Patent document 1) is about TD control, that is, a technique to control misalignment in a transverse direction. In Patent document 1, a support base for a feed roller that feeds film materials is configured to have a rotary support shaft at the width center of the support base so that the support base can be swung left and right, and to pivot on this shaft. Japanese Patent Application Laid-Open Publication No. 2015-24506 (Patent document 2) is about MD control, that is, a technique to control misalignment in a longitudinal direction. In patent document 2, dancer rollers function to lengthen or shorten the path length of either of upper and lower film materials and thereby eliminate misalignment.

### SUMMARY OF THE INVENTION

### Problems to be Solved by the Invention

The configuration according to Patent document 1, however, requires a rotation function to be provided on the feed roller support base, which makes the configuration complicated. The configuration according to Patent document 2 involves moving up and down a plurality of dancer rollers each provided between a heat-sealing unit, a cooling unit, and other processing units in an integrated manner, which also makes the configuration complicated. Moreover, the configuration according to Patent document 1 can only allow for correcting misalignment in a transverse direction of the film materials, and the configuration according to Patent document 2 can only allow for correcting misalignment in a longitudinal direction of the film materials.

A purpose of the disclosure made in view of the above is to provide a controller of a pouch-making machine, a pouch-making machine, a pouch, a control method for a pouch-making machine, and a control program for a pouch-making machine that allow for correcting misalignment of print designs occurring on a pair of film materials with a simple configuration.

### Means for Solving the Problems

A controller for a pouch-making machine of an aspect of the disclosure is a controller for a pouch-making machine for manufacturing a pouch while feeding a pair of film materials each provided with a reference mark that indicates a reference position for layering the film materials together, and the controller for the pouch-making machine comprises: a driven roller shift unit for independently shifting each shaft of a pair of driven rollers that rotate being driven by the pair of film materials being fed; and a control unit for controlling the driven roller shift unit based on a result of an image-shooting unit shooting images of the reference marks, so that positions of the reference marks provided on the pair of film materials coincide.

In this configuration, the pair of driven rollers each rotate corresponding to each of the pair of film materials. Each of the pair of driven rollers then independently shifts so that the positions of the reference marks provided on the pair of film materials coincide. Accordingly, this configuration allows the path lengths of the film materials to be adjusted by the shift of the driven rollers, and therefore allows for correcting misalignment of print designs occurring on the pair of film materials with a simple configuration.

In the controller for the pouch-making machine described above, the driven roller shift unit may independently shift each shaft of the pair of driven rollers at each end. This configuration allows for correcting the misalignment in the film materials' feed and width directions with ease.

In the controller for the pouch-making machine described above, if either of the reference marks on the film materials is misaligned in the film materials' feed direction, the control unit may shift both ends of the shaft of the driven roller corresponding to the film material where the misalignment is occurring depending on the misalignment. This configuration allows for correcting the misalignment in the film materials' feed direction with ease.

In the controller for the pouch-making machine described above, if either of the reference marks on the film materials is misaligned in the film materials' width direction, the control unit may shift one end of the shaft of the driven roller corresponding to the film material where the misalignment is occurring depending on the misalignment. This configuration allows for correcting the misalignment in the film materials' width direction with ease.

A pouch-making machine of an aspect of the disclosure is for manufacturing a pouch while feeding a pair of film materials each provided with a reference mark that indicates a reference position for layering the film materials together, and the pouch-making machine comprises: a pair of driven rollers that rotate being driven by the pair of film materials being fed; an image-shooting unit for shooting images of the reference marks provided on the pair of film materials; and the controller described above. This configuration allows for correcting misalignment of print designs occurring on the pair of film materials with a simple configuration.

In the pouch-making machine described above, the pair of driven rollers may be installed upstream of and adjacent to a feed roller that layers together and feeds the pair of film materials. This configuration allows for correcting misalignment of the pair of film materials before they are layered together.

In the pouch-making machine described above, the image-shooting unit may be installed in the film materials' path downstream of a feed roller that layers together and feeds the pair of film materials and forward of where the pair of film materials are sealed. This configuration allows for correcting misalignment of the pair of film materials with a simple configuration.

A pouch of an aspect of the disclosure is manufactured by the pouch-making machine described above.

A control method for a pouch-making machine of an aspect of the disclosure is a control method for a pouch-making machine for manufacturing a pouch while feeding a pair of film materials each provided with a reference mark that indicates a reference position for layering the film materials together, and the control method for the pouch-making machine has: a first step of an image-shooting unit shooting images of the reference marks provided on the pair of film materials; and a second step of, based on a result of the image-shooting unit shooting images of the reference marks, controlling independent shifting of each shaft of a pair of driven rollers that rotate being driven by the pair of film materials being fed, so that positions of the reference marks provided on the pair of film materials coincide.

A control program for a pouch-making machine of an aspect of the disclosure is a control program for a pouch-making machine for manufacturing a pouch while feeding a pair of film materials each provided with a reference mark that indicates a reference position for layering the film materials together, and the control program for the pouch-making machine causes a computer to execute: a first step of an image-shooting unit shooting images of the reference marks provided on the pair of film materials; and a second step of, based on a result of the image-shooting unit shooting images of the reference marks, controlling independent shifting of each shaft of a pair of driven rollers that rotate being driven by the pair of film materials being fed, so that positions of the reference marks provided on the pair of film materials coincide.

### Advantage of the Invention

The disclosure allows for correcting misalignment of print designs occurring on a pair of film materials with a simple configuration.

### BRIEF DESCRIPTION OF THE DRAWINGS

FIG. 1 is a schematic drawing of a pouch-making machine of an embodiment.

FIG. 2 is a schematic drawing of lip rollers, a feed roller, and cameras of the embodiment.

FIG. 3 is a schematic drawing showing a reference mark of the embodiment, where (A) shows a case in which the reference mark is in a normal position, and (B) shows a case in which the reference mark is misaligned.

FIG. 4 is a function block diagram related to a film misalignment correction function of the embodiment.

FIG. 5 is a flowchart showing a flow of the film misalignment correction function.

FIG. 6 is a flowchart showing a flow of the film misalignment correction function.

FIG. 7 is a schematic diagram showing another mode of the lip rollers.

### MODES OF EMBODYING THE INVENTION

An embodiment of the disclosure will now be described with reference to the drawings. The embodiment described below is merely illustrative of ways to implement the disclosure, and does not limit the disclosure to the specific configurations described below. When the disclosure is to be implemented, any specific configuration may be appropriately adopted according to the mode of implementation.

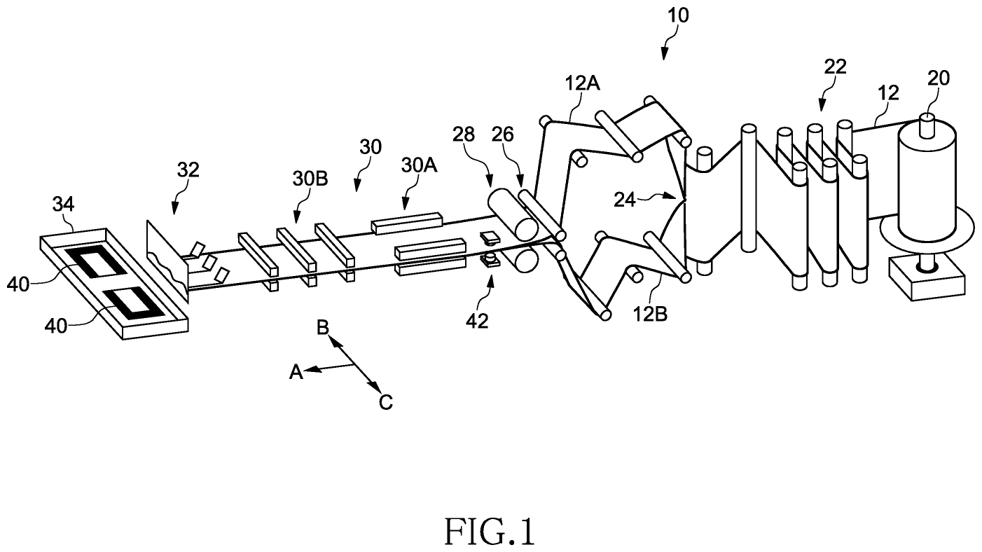

FIG. 1 is a schematic drawing of a pouch-making machine 10 of the embodiment. The pouch-making machine 10 of the embodiment manufactures a pouch formed by three-side sealing (three-side seal pouch, also called four-side pouch) from one sheet of film material 12.

The pouch-making machine 10 of the embodiment comprises a supply roller 20, dancer rollers 22, an M plate 24, lip rollers 26, a feed roller 28, a seal unit 30, a cutting unit 32, and a receiving unit 34.

The supply roller 20 supplies the film material 12 printed and laminated for pouch-making.

The dancer rollers 22 are provided to buffer between the film material 12 continuously supplied from the supply roller 20 and flowing in the upper stream and the film material 12 intermittently moving for heat sealing in the middle and lower streams. For this purpose, the dancer rollers 22 comprise a plurality of driven rollers, each of which rotates being driven by the film material 12 being fed and moves in directions perpendicular to the feed direction of the film material 12. Note that the feed direction of the film material 12 is the direction indicated by an arrow A in FIG. 1, and the perpendicular directions are directions indicated by arrows B and C. The perpendicular directions are also called the width direction, the right (the direction of the arrow B), or the left (the direction of the arrow C) of the film material 12.

The M plate 24 cuts the fed film material 12 into two, that is, a pair of film materials 12A and 12B (a film material 12A and a film material 12B). The pair of film materials 12A and 12B are fed separately on the upper and lower sides, respectively. The pair of film materials 12A and 12B, which have been cut apart, are made into pouches 40 and thus form the front and back surfaces of the pouches 40. Note that the pair of film materials 12A and 12B are simply called the film material(s) 12 in the description below when they are not separately described.

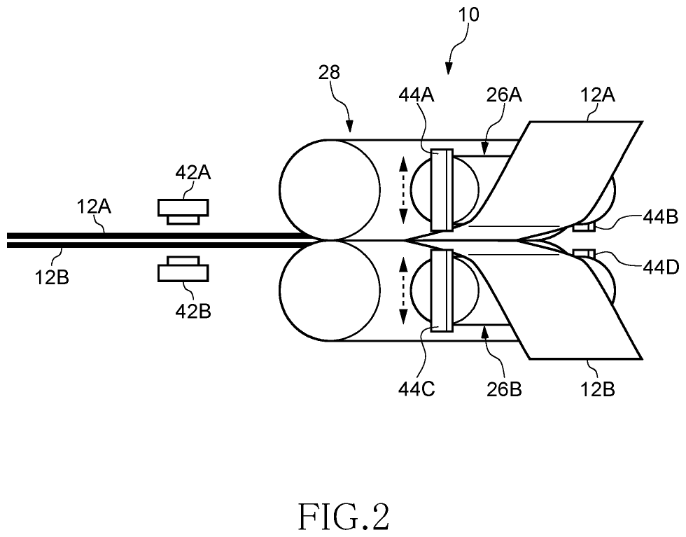

The lip rollers 26 have an upper lip roller 26A and a lower lip roller 26B (see FIG. 2), each of which corresponds to each of the pair of film materials 12A and 12B, and are a pair of driven rollers rotate being driven by the film materials 12 being fed. The lip rollers 26 are installed upstream of and adjacent to the feed roller 28.

As will be described in detail later, the lip rollers 26 have a function to adjust misalignment in the feed and width directions of the pair of film materials 12A and 12B. For this purpose, the upper lip roller 26A and the lower lip roller 26B are positioned apart from each other.

The feed roller 28 is a driving roller that rotates nipping the pair of film materials 12A and 12B with a constant pressure so as to layer together and feed them.

The seal unit 30 heat-seals the pair of film materials 12A and 12B being layered together and fed by the feed roller 28. The seal unit 30 in the embodiment comprises a longitudinal seal unit 30A and a transverse seal unit 30B, and heat-seals the pouches 40 on the longitudinal and transverse sides for sealing.

The cutting unit 32 cuts the sealed film materials 12 into sheets so that they become the pouches 40. The cutting unit 32 of the embodiment cuts the sealed film materials 12 along the feed direction, and then cuts them in a direction perpendicular to the feed direction, thereby cutting the film materials 12 into two pouches in each one shot.

The receiving unit 34 receives the manufactured pouches 40.

As seen above, the pouch-making machine 10 of the embodiment manufactures the pouches 40 while feeding the pair of film materials 12A and 12B, and driven rollers and driving rollers other than the various rollers described above may be positioned in the path of the film materials 12 as appropriate.

The film materials 12 of the embodiment may be used as the pouches 40 for so-called flexible packaging, may have substrate and sealant layers, and may be provided with an interlayer between the substrate and sealant layers.

The material of the substrate layer includes, for example, polyethylene terephthalate (PET), polypropylene (PP), and polyamide (PA), and biaxially stretched films of these materials or other stretched films are preferable. Vapor deposition films evaporated with metal such as aluminum or magnesium, oxides thereof, silicon oxides, or the like, or coat films coated with barrier substances such as ethylene-vinylalcohol copolymer (EVOH) and polyvinylidene chloride, or the like may also be used in order to give the film materials 12 barrier properties against oxygen and water vapor. The substrate layer may be a single one of the above-mentioned films or a laminate comprising a plurality of films.

The sealant layer is, for example, a layer capable of being heated and melted within a temperature range in which the form of the substrate layer can be maintained, and of being heat-sealed. The material of the sealant layer includes, for example, polyethylene (PE) such as high-density polyethylene (HDPE), low-density polyethylene (LDPE), and linear low-density polyethylene (LLDPE), and PP, and unstretched films of these materials or multilayer extrusions of these materials are preferable.

The material of the interlayer includes, for example, films provided with functionalities such as oxygen barrier properties, water vapor barrier properties, and tear strength. Specific examples of the interlayer include, for example, aluminum (AL) foil, polyamide (PA) films (ONY films), and laminate films using a linear low-density polyethylene (LLDPE) film for the sealant layer. Dry lamination methods (DL) using adhesives, extrusion lamination methods using thermoplastic resins, or other known methods are applied as a method of laminating the laminate films.

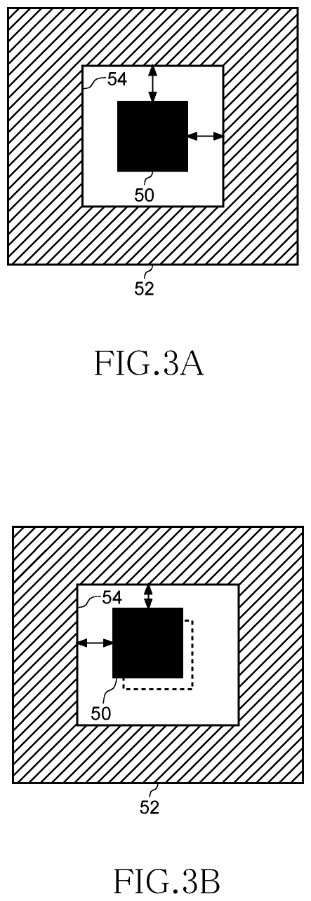

The pouch-making machine 10 of the embodiment feeds and seals the pair of film materials 12A and 12B so that the positions of positioning print designs (hereinafter referred to as the “reference marks”) 50 provided on them coincide. The reference marks 50 are also called register marks or eye marks, and are provided by being printed on the film materials 12. The reference marks 50 will be described in detail later with reference to FIG. 3.

The pouch-making machine 10 of the embodiment is provided with cameras 42 for shooting images of the reference marks 50. Based on a result of the cameras 42 shooting images of the reference marks 50, the pouch-making machine 10 of the embodiment controls the lip rollers 26 so that the positions of the reference marks 50 provided on the pair of film materials 12A and 12B coincide.

FIG. 2 is a schematic drawing of the lip rollers 26, the feed roller 28, and the cameras 42 of the pouch-making machine 10 of the embodiment.

The cameras 42 are installed in the path of the film materials 12 downstream of the feed roller 28 and forward of where the pair of film materials 12A and 12B are sealed.

The cameras 42 comprise an upper camera 42A and a lower camera 42B in order to shoot images of the reference marks 50 each provided on each of the pair of film materials 12A and 12B. That is, the upper camera 42A shoots, from above, an image of the reference mark 50 provided on the film material 12A being fed. The lower camera 42B shoots, from below, an image of the reference mark 50 provided on the film material 12B being fed.

The lip rollers 26 of the embodiment are provided with a lip roller shift unit 44 for independently shifting each shaft of the upper lip roller 26A and the lower lip roller 26B.

The lip roller shift unit 44 of the embodiment independently shifts each shaft of the pair of lip rollers 26A and 26B at each end by means of actuators. For this purpose, the lip roller shift unit 44 comprises as the actuators an upper lip roller left end actuator 44A, an upper lip roller right end actuator 44B, a lower lip roller left end actuator 44C, and a lower lip roller right end actuator 44D. Both ends of the shafts of the upper lip roller 26A and the lower lip roller 26B are each supported by a bearing described later, and the independent shifting of each shaft at each end can be performed by, for example, shifting a relevant one of the bearings.

The upper lip roller left end actuator 44A is a drive device for vertically shifting the left end of the upper lip roller 26A. The upper lip roller right end actuator 44B is a drive device for vertically shifting the right end of the upper lip roller 26A. The lower lip roller left end actuator 44C is a drive device for vertically shifting the left end of the lower lip roller 26B. The lower lip roller right end actuator 44D is a drive device for vertically shifting the right end of the lower lip roller 26B.

The left and right ends of the shaft of the upper lip roller 26A are each provided with a self-aligning bearing. The left and right bearings of the upper lip roller 26A are attached in an H shape to an unshown frame via the upper lip roller left end actuator 44A and the upper lip roller right end actuator 44B. Similarly, the left and right ends of the shaft of the lower lip roller 26B also are each fitted with a self-aligning bearing. The left and right bearings of the lower lip roller 26B are attached in an H shape to the unshown frame via the lower lip roller left end actuator 44C and the lower lip roller right end actuator 44D so that the lower lip roller 26B becomes approximately parallel to the upper lip roller 26A.

FIG. 3 is a schematic drawing showing one of the reference marks 50. The cameras 42 take close-up photos of the print surfaces of the film materials 12, thereby shooting images of the reference marks 50. Each reference mark 50 of the embodiment has a unicolor quadrangular design, where two opposite sides are parallel to the feed direction of the film materials 12 and the other two sides are perpendicular to the feed direction.

A reference member 52 for determining the position of each reference mark 50 is provided between each camera 42 and each film material 12. Each reference member 52 is a plate-like member from which a quadrangular area (hereinafter referred to as a “window”) 54 larger in size than each reference mark 50 is cut out. Similarly to each reference mark 50, two opposite sides of each window 54 are parallel to the feed direction of the film materials 12 and the other two sides are perpendicular to the feed direction.

FIG. 3(A) shows a case in which one of the reference marks 50 is in a normal position, where the reference mark 50 is positioned at the same distance from four sides forming the window 54, that is, at the center of the window 54. In contrast, FIG. 3(B) shows a case in which the reference mark 50 is misaligned, where the reference mark 50 is off the center of the window 54 and is not positioned at the same distance from the four sides forming the window 54. Note that a quadrilateral shown by broken lines in FIG. 3(B) indicates the reference mark 50 in the normal position. In this manner, the embodiment involves measuring the distance between each side of each reference mark 50 and each side of each window 54 by means of each camera 42, and thus the amount of misalignment of each reference mark 50 from the normal position is determined.

The normal position may be set as predetermined distances from the four sides forming the window 54, or may be acquired based on the average obtained from images of the reference marks 50 shot multiple times by the cameras 42 during actual feed of the film materials 12 by the pouch-making machine 10.

Now, the existence of misalignment of the reference marks 50 from the normal position would suggest misalignment of the film materials 12 being fed. Manufacturing pouches without eliminating such misalignment would result in manufacturing the pouches 40 with front and back print designs misaligned.

For this reason, the pouch-making machine 10 of the embodiment has a film misalignment correction function. The film misalignment correction function of the embodiment is a function to adjust the positions of the lip rollers 26 by controlling the lip roller shift unit 44 based on a result of the cameras 42 shooting images of the reference marks 50, so that the positions of the reference marks 50 provided on the pair of film materials 12A and 12B coincide. That is, if the positions of the reference marks 50 provided on the pair of film materials 12A and 12B both become in the normal position, the positions of the reference marks 50 on the pair of film materials 12A and 12B will coincide.

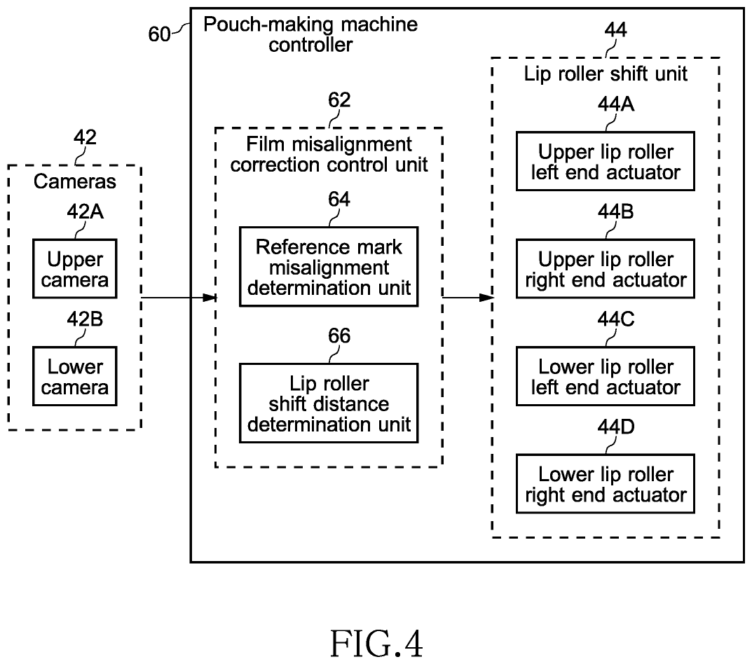

FIG. 4 is a function block diagram related to the film misalignment correction function that the pouch-making machine 10 of the embodiment has.

The pouch-making machine 10 has a pouch-making machine controller 60. The pouch-making machine controller 60 controls the pouch-making machine 10 so as to make pouches from the film materials 12, that is, it controls the rotation of the feed roller 28, the heating and operation of the seal unit 30, and the operation of the cutting unit 32.

The pouch-making machine controller 60 of the embodiment comprises the lip roller shift unit 44 and a film misalignment correction control unit 62 in order to perform the film misalignment correction function.

The film misalignment correction control unit 62 comprises a reference mark misalignment determination unit 64 and a lip roller shift distance determination unit 66, and determines the shift distances of the lip rollers 26 based on a result of the cameras 42 shooting images of the reference marks 50. Note that the function of the film misalignment correction control unit 62 may be realized by an individual hardware component such as a computer that the pouch-making machine controller 60 has and an ASIC (Application Specific Integrated Circuit) that the pouch-making machine controller 60 has.

The reference mark misalignment determination unit 64 determines the amounts of misalignment of the reference marks 50 each provided on the pair of film materials 12A and 12B based on data on images of the reference marks 50 shot by the upper camera 42A and the lower camera 42B.

The lip roller shift distance determination unit 66 determines the shift distances of the lip rollers 26 based on a result of the reference mark misalignment determination unit 64 determining the amounts of misalignment of the reference marks 50.

If either of the reference marks 50 on the film materials 12 is misaligned in the feed direction of the film materials 12, the lip roller shift distance determination unit 66 determines the shift distance so as to shift both ends of the shaft of the lip roller 26 corresponding to the film material 12 where the misalignment is occurring depending on the amount of misalignment. If either of the reference marks 50 on the film materials 12 is misaligned in the width direction of the film materials 12, the lip roller shift distance determination unit 66 determines the shift distance so as to shift one end of the shaft of the lip roller 26 corresponding to the film material 12 where the misalignment is occurring depending on the amount of misalignment.

The shift distance of each lip roller 26 may then be determined by a predetermined equation with the amount of misalignment as a variable, or by a table (list) indicating the relation between the amount of misalignment and the shift distance.

The lip roller shift unit 44 drives the upper lip roller left end actuator 44A, the upper lip roller right end actuator 44B, the lower lip roller left end actuator 44C, and the lower lip roller right end actuator 44D according to the shift distances determined by the lip roller shift distance determination unit 66, and shifts the lip rollers 26.

While the lip roller shift unit 44 determines the drive amounts of the actuators from the shift distances of the lip rollers 26, the determination method is not limited to this, and it may determine the drive amounts of the actuators directly from the amounts of misalignment of the reference marks 50. In such a case, the drive amount of each actuator may be determined by a predetermined equation with the amount of misalignment as a variable, or by a table (list) indicating the relation between the amount of misalignment and the drive amount.

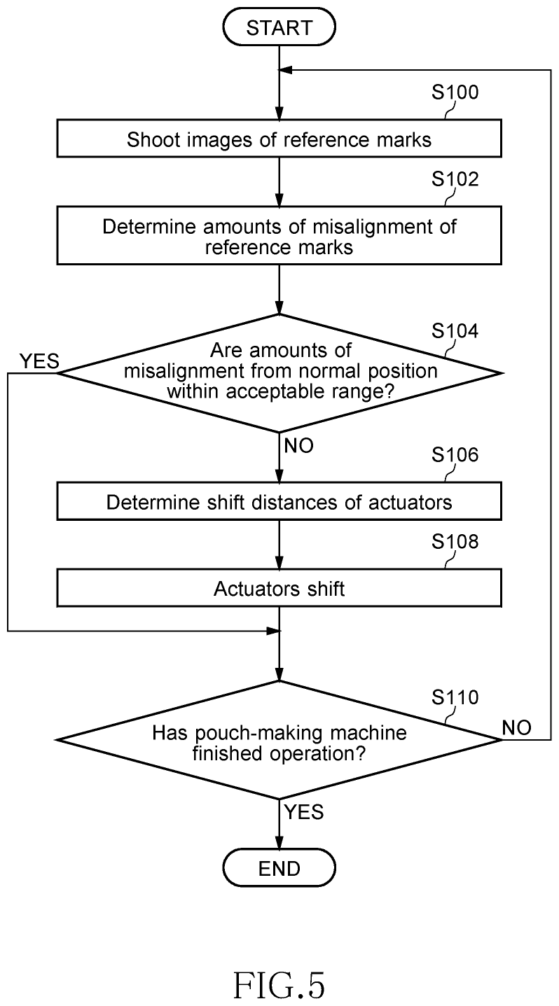

FIG. 5 is a flowchart showing a flow of the film misalignment correction function (hereinafter referred to as the “film misalignment correction process”). The film misalignment correction process is executed when the pouch-making machine 10 is operating and manufacturing the pouches 40 from the film materials 12.

First at a step 100, the upper camera 42A shoots an image of the reference mark 50 on the film material 12A (hereinafter referred to as the “upper reference mark”) and the lower camera 42B shoots an image of the reference mark 50 on the film material 12B (hereinafter referred to as the “lower reference mark”) at a predetermined timing. The timing of the image shooting of the embodiment is when the feed of the film materials 12 is intermittently stopped in order for the seal unit 30 to heat-seal the pair of film materials 12A and 12B.

At the next step 102, the reference mark misalignment determination unit 64 determines the amounts of misalignment of the reference marks 50 from the normal position based on the result of the cameras 42 shooting the images.

At the next step 104, the reference mark misalignment determination unit 64 determines whether the amounts of misalignment are within a predetermined acceptable range or not, and the process proceeds to a step 110 if the determination is affirmative and to a step 106 if the determination is negative.

At the step 106, the lip roller shift distance determination unit 66 determines the shift distances of the actuators based on the amounts of misalignment.

At the next step 108, the actuators are driven according to the determined shift distances to shift the lip rollers 26.

At the step 110, whether the pouch-making machine 10 has finished the operation or not is determined, the film misalignment correction process ends if the determination is affirmative, and the film misalignment correction process returns to the step 100 to be repeated if the determination is negative.

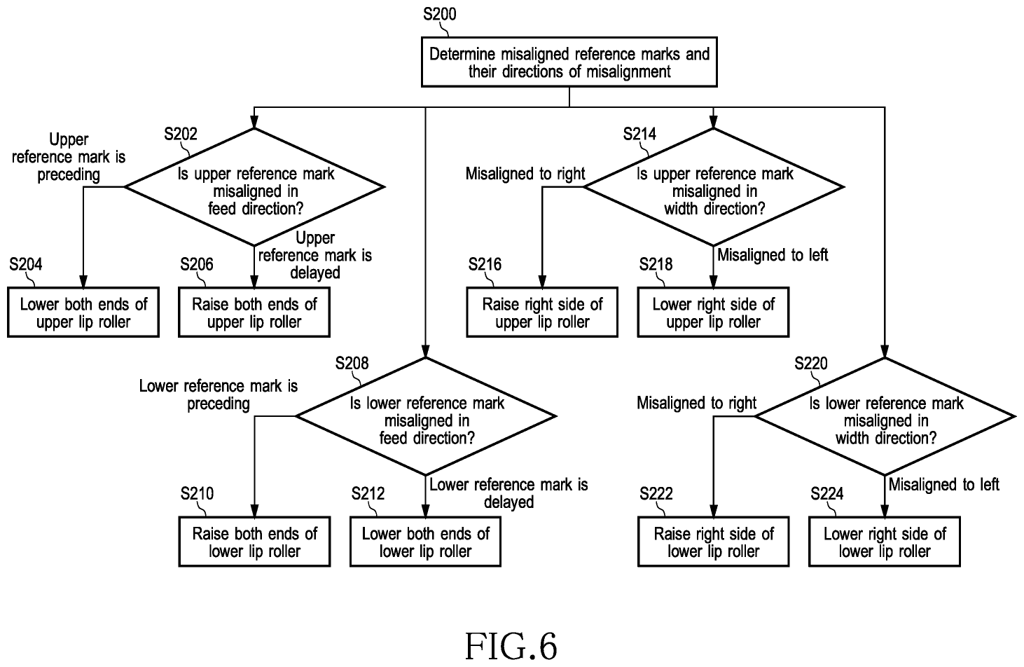

FIG. 6 is a flowchart showing a flow of the process performed at the step 106 in FIG. 5.

First at a step 200, misaligned reference marks 50 and their directions of misalignment are determined.

At a step 202, if it is determined that the upper reference mark is misaligned in the feed direction and is preceding, the process proceeds to a step 204, where the lip roller shift unit 44 lowers both ends of the upper lip roller 26A. In this case, the upper lip roller left end actuator 44A and the upper lip roller right end actuator 44B lower the upper lip roller 26A by the same drive amount that depends on the amount of misalignment.

On the other hand, if it is determined at the step 202 that the upper reference mark is misaligned in the feed direction and is delayed, the process proceeds to a step 206, where the lip roller shift unit 44 raises both ends of the upper lip roller 26A. In this case, the upper lip roller left end actuator 44A and the upper lip roller right end actuator 44B raise the upper lip roller 26A by the same drive amount that depends on the amount of misalignment.

At a step 208, if it is determined that the lower reference mark is misaligned in the feed direction and is preceding, the process proceeds to a step 210, where the lip roller shift unit 44 raises both ends of the lower lip roller 26B. In this case, the lower lip roller left end actuator 44C and the lower lip roller right end actuator 44D raise the lower lip roller 26B by the same drive amount that depends on the amount of misalignment.

On the other hand, if it is determined at the step 208 that the lower reference mark is misaligned in the feed direction and is delayed, the process proceeds to a step 212, where the lip roller shift unit 44 lowers both ends of the lower lip roller 26B. In this case, the lower lip roller left end actuator 44C and the lower lip roller right end actuator 44D lower the lower lip roller 26B by the same drive amount that depends on the amount of misalignment.

At a step 214, if it is determined that the upper reference mark is misaligned to the right in the width direction, the process proceeds to a step 216, where the lip roller shift unit 44 raises the right side of the upper lip roller 26A. In this case, the upper lip roller left end actuator 44A does not drive and the upper lip roller right end actuator 44B raises the right side of the upper lip roller 26A by the drive amount that depends on the amount of misalignment. Note that, as described above, the terms right and left here indicate the right (the arrow B in FIG. 1) and the left (the arrow C in FIG. 1) when facing in the feed direction of the film materials 12 (the arrow A in FIG. 1).

If it is determined at the step 214 that the upper reference mark is misaligned to the left in the width direction, the process proceeds to a step 218, where the lip roller shift unit 44 lowers the right side of the upper lip roller 26A. In this case, the upper lip roller left end actuator 44A does not drive and the upper lip roller right end actuator 44B lowers the right side of the upper lip roller 26A by the drive amount that depends on the amount of misalignment.

At a step 220, if it is determined that the lower reference mark is misaligned to the right in the width direction, the process proceeds to a step 222, where the lip roller shift unit 44 raises the right side of the lower lip roller 26B. In this case, the lower lip roller left end actuator 44C does not drive and the lower lip roller right end actuator 44D raises the right side of the lower lip roller 26B by the drive amount that depends on the amount of misalignment.

If it is determined at the step 220 that the lower reference mark is misaligned to the left in the width direction, the process proceeds to a step 224, where the lip roller shift unit 44 lowers the right side of the lower lip roller 26B. In this case, the lower lip roller left end actuator 44C does not drive and the lower lip roller right end actuator 44D lowers the right side of the lower lip roller 26B by the drive amount that depends on the amount of misalignment.

As described above, the pouch-making machine 10 manufactures the pouches 40 while feeding the pair of film materials 12A and 12B provided with the reference marks 50 that indicate the reference positions for layering the film materials 12 together. If print designs are misaligned in the feed or width direction of the pair of film materials 12A and 12B, the positions of the reference marks 50 are misaligned against the normal position as well. The film misalignment correction process then independently shifts the left and right bearings of the lip rollers 26 in order to correct the positions of the reference marks 50 to the normal position. The shifting of the lip rollers 26 causes an adjustment of the path lengths (the lengths in the feed direction) of the film materials 12 in the feed or width direction, and therefore allows for correcting misalignment of print designs occurring on the pair of film materials 12A and 12B with a simple configuration.

For example, if it is determined that the film material 12A is delayed 0.5 mm in the feed direction, the delay is eliminated by shifting the left and right bearings of the upper lip roller 26A upward so as to shorten the path length of the film material 12A by 0.5 mm.

For another example, if it is determined that the film material 12A is misaligned 0.5 mm to the left in the width direction, the right bearing of the upper lip roller 26A is shifted downward so that the 0.5 mm misalignment is eliminated. When the control is to be performed only for the width direction, the path lengths of the film materials 12 are controlled not to change with the shifting of the bearings of the lip rollers 26.

FIG. 6 shows a case where each reference mark 50 is misaligned in either feed or width direction, but if the misalignment is occurring in both feed and width directions, combined control is performed so that both returns to the normal position. If both upper and lower reference marks are misaligned, combined control is performed so that each reference mark 50 returns to the normal position.

The embodiment allows for correcting the positions of the reference marks 50 by adjusting the path lengths of the film materials 12 by means of the lip rollers 26 upstream of and adjacent to the feed roller 28 that layers together and feeds the pair of film materials 12A and 12B, and therefore allows misalignment of the reference marks 50 to be corrected more reliably and quickly.

Moreover, since the cameras 42 for shooting images of the reference marks 50 are positioned downstream of and adjacent to the feed roller 28, misalignment of the reference marks 50 can be detected at an early stage, and the full length of the pouch-making machine 10 can be shortened. It is also easy to additionally install the film misalignment correction function of the embodiment to a conventional pouch-making machine 10.

While the disclosure has been described with reference to the above embodiment, the technical scope of the disclosure is not limited to the scope provided by the embodiment.

Various modifications or improvements can be made to the embodiment without departing from the gist of the disclosure, and those added with the modifications or improvements are also included in the technical scope of the disclosure.

While a description has been made for the above embodiment on a mode of the pouch-making machine 10 in which the M plate 24 cuts one sheet of film material 12 into two, upper and lower, film materials 12A and 12B after the supply roller 20 supplies the sheet of film material 12, the disclosure is not limited to this. For example, there may be another mode of the pouch-making machine 10 which supplies two precut film materials 12A and 12B, or the like. Moreover, the pouch-making machine 10 may have a function as a so-called filling machine that fills pouches with the contents and seals them while making the pouches.

While a description has been made for the above embodiment on a mode in which three-side seal pouches (four-side pouches) are manufactured as the pouches 40, the disclosure is not limited to this. For example, the pouches 40 to be manufactured may be bottom gusset pouches manufactured with a bottom member being inserted (so-called standing pouches), zippered pouches with an inserted plastic zipper, and side gusset pouches.

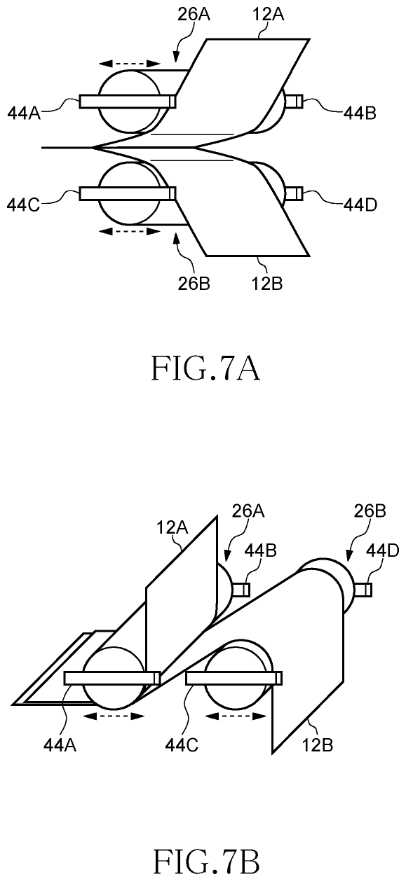

While a description has been made for the above embodiment on a mode in which the pair of lip rollers 26A and 26B shift independently of each other in a direction vertical to the feed direction of the film materials 12, the disclosure is not limited to this. The pair of lip rollers 26A and 26B just have to be able to adjust the path lengths of the film materials 12 being fed, and may shift independently of each other in a direction parallel to the feed direction of the film materials 12 as shown in FIG. 7(A). Instead of the mode in which the pair of lip rollers 26A and 26B are positioned in a vertical direction, the lip rollers 26A and 26B may be positioned in a direction parallel (a direction horizontal) to the feed direction of the film materials 12 as shown in FIG. 7(B), or the pair of lip rollers 26A and 26B may be positioned on different levels so that they are not arranged vertically nor horizontally.

While a description has been made for the above embodiment on a mode in which the left and right bearings of the lip rollers 26 are moved independently, the disclosure is not limited to this. For example, there may be a mode in which the left and right bearings of each lip roller 26 do not move independently, that is, the left and right bearings of each lip roller 26 move only at the same time and by the same amount.

While a description has been made for the above embodiment on a mode in which the amount of misalignment of each reference mark 50 is determined by the distance from each window 54 in each reference member 52 to the reference mark 50, the disclosure is not limited to this. For example, the angle of view of each camera 42 may be used as a reference, and the amount of misalignment of each reference mark 50 may be determined by the distance from the periphery of the angle of view to the reference mark 50. The reference members 52 do not have to be provided in this mode.

Either of the reference marks 50 provided on the pair of film materials 12A and 12B may be used as a reference. In this mode, the lip roller 26 corresponding to the film material 12 provided with the other reference mark 50 is shifted so that the position of the other reference mark 50 coincides with the position of the reference mark 50 used as the reference.

### DESCRIPTION OF THE SYMBOLS

10: Pouch-making machine
12: Film material
26: Lip roller (Driven roller)
28: Feed roller (Feed roller)
40: Pouch
42: Camera (Image-shooting unit)
50: Reference mark
60: Pouch-making machine controller (Controller)
62: Film misalignment correction control unit (Control unit)

1-10. (canceled)

11. A controller for a pouch-making machine for manufacturing a pouch while feeding a pair of film materials each provided with a reference mark that indicates a reference position for layering the film materials together, the controller for the pouch-making machine comprising:
a driven roller shift unit for independently shifting each shaft of a pair of driven rollers that rotate being driven by the pair of film materials being fed; and
a control unit for controlling the driven roller shift unit based on a result of an image-shooting unit shooting images of the reference marks, so that positions of the reference marks provided on the pair of film materials coincide.

12. The controller according to claim 11, wherein the driven roller shift unit independently shifts each shaft of the pair of driven rollers at each end.

13. The controller according to claim 11, wherein if either of the reference marks on the film materials is misaligned in the film materials' feed direction, the control unit shifts both ends of the shaft of the driven roller corresponding to the film material where the misalignment is occurring depending on the misalignment.

14. The controller according to claim 12, wherein if either of the reference marks on the film materials is misaligned in the film materials' feed direction, the control unit shifts both ends of the shaft of the driven roller corresponding to the film material where the misalignment is occurring depending on the misalignment.

15. The controller according to claim 11, wherein if either of the reference marks on the film materials is misaligned in the film materials' width direction, the control unit shifts one end of the shaft of the driven roller corresponding to the film material where the misalignment is occurring depending on the misalignment.

16. The controller according to claim 12, wherein if either of the reference marks on the film materials is misaligned in the film materials' width direction, the control unit shifts one end of the shaft of the driven roller corresponding to the film material where the misalignment is occurring depending on the misalignment.

17. The controller according to claim 13, wherein if either of the reference marks on the film materials is misaligned in the film materials' width direction, the control unit shifts one end of the shaft of the driven roller corresponding to the film material where the misalignment is occurring depending on the misalignment.

18. The controller according to claim 14, wherein if either of the reference marks on the film materials is misaligned in the film materials' width direction, the control unit shifts one end of the shaft of the driven roller corresponding to the film material where the misalignment is occurring depending on the misalignment.

19. The controller according to claim 11, wherein if either of the reference marks on the film materials is misaligned in the film materials' feed direction, the control unit shifts both ends of the shaft of the driven roller corresponding to the film material where the misalignment is occurring depending on the misalignment, if either of the reference marks on the film materials is misaligned in the film materials' width direction, the control unit shifts one end of the shaft of the driven roller corresponding to the film material where the misalignment is occurring depending on the misalignment.

20. The controller according to claim 12, wherein if either of the reference marks on the film materials is misaligned in the film materials' feed direction, the control unit shifts both ends of the shaft of the driven roller corresponding to the film material where the misalignment is occurring depending on the misalignment, if either of the reference marks on the film materials is misaligned in the film materials' width direction, the control unit shifts one end of the shaft of the driven roller corresponding to the film material where the misalignment is occurring depending on the misalignment.

21. A pouch-making machine for manufacturing a pouch while feeding a pair of film materials each provided with a reference mark that indicates a reference position for layering the film materials together, the pouch-making machine comprising:
a pair of driven rollers that rotate being driven by the pair of film materials being fed;
an image-shooting unit for shooting images of the reference marks provided on the pair of film materials; and
the controller according to claim 11.

22. The pouch-making machine according to claim 21, wherein the pair of driven rollers are installed upstream of and adjacent to a feed roller that layers together and feeds the pair of film materials.

23. The pouch-making machine according to claim 21, wherein the image-shooting unit is installed in the film materials' path downstream of a feed roller that layers together and feeds the pair of film materials and forward of where the pair of film materials are sealed.

24. The pouch-making machine according to claim 21, wherein if either of the reference marks on the film materials is misaligned in the film materials' feed direction, the control unit shifts both ends of the shaft of the driven roller corresponding to the film material where the misalignment is occurring depending on the misalignment, if either of the reference marks on the film materials is misaligned in the film materials' width direction, the control unit shifts one end of the shaft of the driven roller corresponding to the film material where the misalignment is occurring depending on the misalignment.

25. A pouch manufactured by the pouch-making machine according to claim 21.

26. A control method for a pouch-making machine for manufacturing a pouch while feeding a pair of film materials each provided with a reference mark that indicates a reference position for layering the film materials together, the control method for the pouch-making machine having:
a first step of an image-shooting unit shooting images of the reference marks provided on the pair of film materials; and
a second step of, based on a result of the image-shooting unit shooting images of the reference marks, controlling independent shifting of each shaft of a pair of driven rollers that rotate being driven by the pair of film materials being fed, so that positions of the reference marks provided on the pair of film materials coincide.

27. A control program for a pouch-making machine for manufacturing a pouch while feeding a pair of film materials each provided with a reference mark that indicates a reference position for layering the film materials together, the control program for the pouch-making machine causing a computer to execute:
a first step of an image-shooting unit shooting images of the reference marks provided on the pair of film materials; and
a second step of, based on a result of the image-shooting unit shooting images of the reference marks, controlling independent shifting of each shaft of a pair of driven rollers that rotate being driven by the pair of film materials being fed, so that positions of the reference marks provided on the pair of film materials coincide.
